(19) United States
(12) Patent Application Publication
(10) Pub. No.: US 2007/0298366 A1
(43) Pub. Date: Dec. 27, 2007

(54) Orthodontic Jaw Wiring, a fixed intra-oral device and method to limit jaw opening, thereby preventing ingestion of solid food

(75) Inventor: TEDDY ROTHSTEIN, Brooklyn, NY (US)

Correspondence Address: MICHAEL RIES, 318 PARKER PLACE, OSWEGO, IL, 60543, US

(73) Assignee: TEDDY ROTHSTEIN, BROOKLYN, NY (US)

(21) Appl. No.: 11/534,225

(22) Filed: Sep. 22, 2006

Related U.S. Application Data
(60) Provisional application No. 60/817,245, filed on Jun. 27, 2006.

(51) Int. Cl. A61C 3/00

(52) U.S. Cl. 433/19

(57) ABSTRACT

Orthodontic jaw wiring is a fixed intra-oral, bio-mechanical device and method for treating and controlling compulsive overeating and obesity. The device is composed of orthodontic brackets attached to the teeth, and pliable wire wrapped either around or through the brackets. The brackets are optimally positioned with respect to the anterior-posterior position of the lower jaw. The wiring is configured to suspend the patient's lower jaw in a semi-closed, partially movable resting position which permits a moderate amount of physiologic jaw movement and relatively clear speech, while inhibiting the ingestion of solid foods.

### CLAIM TO PROVISIONAL APPLICATION

This application claims the benefit of U.S. Provisional Application No. 60/871,245 filed Jun. 27, 2006.

### BACKGROUND OF THE INVENTION

1. The Field of the Invention

The invention relates to a dental device and method to prevent overeating and thereby treat or help control overweight, obesity and compulsive overeating.

2. Description of the prior art

While there are many control methods, notably, over-the counter medicines, specialized pharmaceuticals, fad diets, proprietary weight loss programs, psychotherapeutic counseling, weight loss clinics, clinics specializing in proprietary liquid diets, exercise programs and a variety of gastric-intestinal surgical procedures, the field of endeavor of orthodontic jaw wiring is the control of obesity by means of intra-oral dental devices which overall can be classified as either fixed or removable. Orthodontic jaw wiring is considered a fixed non-removable intra-oral device.

Unlike other dental applications which close the jaws completely together or employ removable devices to limit, slow down or constrain the ingestion of solid foods, the current invention has at its goal to limit the separation of the jaws; is kept on at all times and consequently mandates the patient be limited to a liquid diet.

Three types of devices and methods that limit, slow or otherwise constrain caloric ingestion by mechanical means shall be herein outlined. They include: 1. Maxillo-Mandibular Fixation, 2. Fixed Barrier devices and 3. Removable devices.

1. Maxillo-Mandibular Fixation (MMF)

MMF is a surgical procedure practiced exclusively by oral surgeons wherein metal “full mouth arch bars” are wired on to the teeth of the upper and lower jaws, which are then fastened to each other, usually by elastics, which consequently keep the upper and lower teeth in contact rendering the jaws totally immobilized. The procedure takes at least an hour for a skillful oral surgeon to accomplish, and requires the patient to be placed in and removed from general anesthesia or intravenous sedation.

Often referred to as “jaw wiring”, the primary purpose of MMF is to keep a broken jaw(s) aligned and stable to facilitate healing. Little attention has been paid to the problem of stiffening of the jaw joints resulting from immobilization over prolonged periods of time.

Jaw wiring has never been included in the curriculum of the art and science of oral surgery for any other primary application except as an aid to healing broken and pathologically involved jaws.

The sole study on jaw wiring as done by oral surgeons for the control of obesity was reported Jun. 11, 1977 in Lancet, a respected medical journal. The authors concluded, “Jaw wiring is a simple effective procedure which can be carried out in most hospitals, and has a place in an integrated approach to obesity”.

The definition of “integrated” is not given, affording no additional guidance on how MMF may be safely and effectively used to treat and prevent overeating and obesity. Several key questions that are fundamental to any healthcare practitioner are left open and in question, including: how are patients chosen or eliminated as candidates? How are patients educated on the procedure so that they may make an informed decision whether the procedure is right for them? Is the procedure provided under the auspices of a single oral surgeon, or the auspices of a heath-care team including physician, dentist, dietician and even psychotherapist if warranted?

There is no doubt that MMF jaw wiring immediately preceded the inception of orthodontic jaw wiring for weight control, since weight loss had been observed, at least in some instances, to be a secondary consequence of the MMF procedure.

In contrast to MMF which is practiced by the oral surgeon, orthodontic jaw wiring, as applied to weight control in the present invention, is intended to be provided by general dentists, and practitioners of the art and science of Orthodontics, by virtue of their skills with the fundamental mechanical constituents of the device, namely orthodontic brackets and wires and a variety of other attachments that dentists, especially orthodontists, bond on to the teeth

Furthermore, in contrast to MMF, the jaws are wired apart in recognition of the need, not only to prevent ingestion of solid foods, but also to prevent or minimize stiffening of the jaw joints over periods of time as long as 6-12 months, allow a reasonable degree of clear speech, and allow the passage of liquids in case of acute and rapid onset of vomiting.

2. Fixed Barrier Devices

In U.S. Pat. No. 4,471,771, Brown and Comstock present a fixed (i.e. attached to the teeth), device which is glued to two upper back molars. The device includes a guard, net, or other sieve-like blocking means secured inside the mouth, allowing the free passage of liquids and finely ground foods, but precludes the ingestion of solid foods. The device purports to allow the user to freely move their tongue and jaws, to talk, to breathe and to drink fluids. In the preferred embodiment, the blocking means functions as a one-way valve, blocking ingestion of solid food, but allowing food within the stomach to pass back out through the mouth (as would occur, for example, during regurgitation).

3. Removable Devices

In U.S. Pat. No. 4,738,259, Brown and Comstock present a device consisting of two independent of each other right and left pieces, each of which is removable. The object of the device is to disrupt natural chewing and transport of food at chewing surfaces of the teeth, thereby impeding the rate of food consumption.

In U.S. Pat. No. 5,924,422, Gustafson presents a removable “plate” resembling an upper denture without the teeth, which has along its center a thick build up of plastic material. The device is clipped on the teeth by metal clasps. The device has a portion of reduced thickness toward the front of the mouth and a portion of increased thickness toward the back of the mouth when the molded element is removably positioned in fixed relationship against the roof of the mouth. The object of the device is to alter the configuration of the palate, whereby the food-containing volume of the mouth is reduced and the quantity of food per bite is reduced.

### THE INVENTION

The invention is a fixed, intra-oral device and method to treat compulsive overeating and obesity by use of a device which permits a semi-opening and partial mobility of the lower jaw. I have named my invention Orthodontic Jaw Wiring, and also refer to it herein by the abbreviation OJW.

Orthodontic jaw wiring is also referred to as “orthodontic-dental jaw wiring,” “dental jaw wiring” and more simply as “jaw wiring” or “jaw wiring for weight loss/control”.

In one embodiment, OJW refers to not only the device and method, but also to the practitioner's assessment of whether or not the patient is a suitable candidate for OJW by means of an information set provided by the patient, and a set of pre-defined suitability criteria.

OJW consists of orthodontic brackets (hooks, eyelets, attachments) bonded or otherwise attached to teeth on each side of the patient's mouth with a wire woven around or through the hooks and tied on each respective side in such a manner as to preclude ingestion of solid food, while simultaneously allowing moderate mobility of the jaw—both vertically and laterally. These attributes achieve the following unique combination of benefits:
A. Weight control through mechanical limitation of the oral cavity's ability to open sufficiently to allow passage of solid foods.
B. Weight control through the fixed nature of the device which, in contrast to removable devices, impedes the user's ability to remove the device at whim and undermine their own weight loss or weight control objectives.
C. The ability of the user to remove the device with a small wire cutter or nail clipper in the event of intolerable physical or mental discomfort.
D. A reasonable degree of normal speech clarity through a certain permission of the jaw's vertical and lateral mobility.
E. The ability to exercise the jaw, through a certain permission of the jaw's vertical and lateral mobility.
F. The ability to pass the contents of the stomach back out through the mouth, as would occur, for example, during regurgitation.
G. The ability to optimize the user's comfort through the inherent nature of the device and method to be mechanically customized for a specific class of bite.

In addition to providing the patient the above unique set of benefits compared with the prior art, the invention is founded upon the following unique set of mechanical and functional attributes that make OJW different from the prior art:
1. The device utilizes orthodontic brackets bonded on to the outward-facing surface of a maximum of 12 back teeth which the patient cannot remove.
2. “Dead-soft” wire (highly malleable over time) is used to wire the jaws up to 4.0 mm apart via the medium of the brackets, thereby preventing ingestion of solid food.
3. The patient can easily remove the wire under duress.
4. Most patients can easily rewire the device with proper instruction.
5. The brackets can be positioned by the dentist/provider to accommodate a wide variety of patients including those with jutting or receding lower jaws.
6. The device allows movement of the jaw which permits reasonable speech clarity and prevents or minimize stiffness of the jaw joints.
7. The device can be constructed without dental molds or labor-intensive laboratory work and expense.

### SUMMARY OF THE INVENTION

The present invention, orthodontic jaw wiring, represents one of many methods to achieve control of weight, and consequently can be applied to the treatment of obesity.

Jaw wiring is a biomechanical device whose origins can be traced to methods used especially by oral surgeons to treat trauma and pathology.

In the process of treatment for fractured jaws or particular jaw pathologies oral surgeons wired their patient's jaws together. Some patients observed an ensuing weight loss due to the inhibition of solid food ingestion by the jaw wiring. Jaw wiring entered the province of dentistry when sufficient numbers of people realized this method had potential benefits since it limits jaw opening preventing ingestion of solid food.

The invention combines materials commonly used by orthodontists (brackets and wires) in a way that resembles what orthodontists do when they care for their patients with crooked teeth.

The invention employs brackets which can be bonded or otherwise attached by either of two methods to the patient's teeth in a variety of positions to allow for patients with varying lower jaw anatomy, whether jutting or receded lower jaw. In one of two preferred embodiments, the bracket has a “throat”—i.e. channel, or groove—in which the wire passes through and resides passively. A “Begg” bracket, FIG. 3b, is one such widely known bracket among orthodontists.

Through the intermediary of the brackets on the teeth, the jaws are wired with dead-soft wire chosen for thickness of size and pliability in configurations which permit opening of the jaws up to approximately 4.0 mm, or in the preferred embodiment where they are wired so as to allow the lower jaw to hang suspended from the upper in a “semi-opened position of physiologic rest”.

The wires are threaded through the brackets or around the brackets and twisted together with orthodontic pliers, and the excess wire is removed.

By choosing one of two patterns of wiring and methodically twisting the wires together, the desired limit of the apartness of the jaws is achieved.

By wiring the jaws in a way which respects the jaw joint's need for mobility, the patient receives the simultaneous benefit of clearer speech while effectively limiting the opening of the lower jaw so as to prevent the ingestion of solid foods.

The device and method for using it are safe and effective when used under the care and supervision of a trained professional.

### A. The Benefits of The Invention for The Dentist/Provider

1. It eliminates the need for (a) the provider to make special dental molds, or (b) for a device to be fabricated at a dental laboratory.
2. For the orthodontist and most general dentists the work of bonding brackets and wiring the jaws are elementary tasks. With respect to the invention, wiring can be taught to, and readily mastered by, most patients or their proxy (such as a friend, parent or spouse). The ability of the patient or their proxy to wire themselves engages the patient as an active partner in the treatment process, and affords both patient and provider the convenience of the patient arming the device without having to travel to the provider.
3. There is no need for consultation prior to providing OJW, as long as the provider diligently reviews the patient's suitability in the context of pre-defined suitability criteria for an OJW candidate and an information set provided by the patient.
4. If a bracket becomes detached or a wire breaks, the device is completely disabled, and the detached bracket and wires are readily removed by the patient from their mouth.
5. If the OJW provider has diligently reviewed the patient's information in the context of the pre-defined candidate suitability criteria, their main responsibility is to affix the device and safeguard the health of the patient's teeth, gums and jaw joint.
6. The OJW provider becomes part of the patient's healthcare team, since the patient's primary health care provider provides the medical clearance for the OJW provider to offer the device to the patient.
7. With OJW the dentist can accommodate most if not all types of lower jaw anatomy whether the lower jaw juts forward or recedes.

### B. The Benefits of The Invention for The Patient

1. The device limits the patient's ability to ingest solid foods—most often the culprit in unwanted and unhealthy weight gain.
2. The patient's jaw joints are unlikely to become stiff because the jaws are wired with a degree of apartness allowing the lower jaw both lateral and horizontal mobility over an extended treatment time.
3. The device in not surgically invasive. In stark contrast to bariatric and other gastrointestinal surgery, OJW has no mortality risk.
4. OJW wiring (but not the brackets) is readily removed by the patient or their proxy in the event of dire circumstances, for example nausea, which could lead to vomiting, or social requirements requiring unrestricted oral movement, for example giving a speech, singing a song, or running a marathon.
5. The semi-opened position of the jaw permits regurgitated food to pass out through the mouth.
6. The semi-open position of the jaw allows relatively clear speech.
7. OJW minimizes cosmetic inconvenience, in that the brackets are placed only on the back teeth; none are placed on the front teeth.
8. Oral hygiene for the outward-facing surfaces of all teeth can be accomplished by normal brushing. Oral hygiene for the inward-surfaces of the teeth is accomplished by means of over-the-counter oral antiseptics. Patients desiring additional oral hygiene may remove the wires for this occasion.
9. Given the many over-the-counter liquid diets containing fiber, vitamins, minerals and other essential nutrients required for daily health, liquid diets can be prescribed without concern. The patient may also consult with a registered dietician if they desire or have special dietary needs.

### DESCRIPTION OF THE DRAWINGS

FIG. 1 A schematic of the typical pattern of placement of brackets and method of wiring the jaws apart in order to suspend lower jaw from the upper jaw in an unstrained rest position. FIG. 1 shows the right side of the mouth depicting the most frequent pattern and method of jaw wiring namely, the “figure 8” wiring configuration. FIG. 1 also shows the teeth that are meant to bear the attachments.

FIGS. 2a and 2b indicating that right and left sides of the mouth are wired identically to achieve equal sided symmetry and balance.

FIG. 3a shows the physical and dimensional details of the “Begg” bracket. FIG. 3b shows the Begg bracket welded to a mesh screen for the purpose increasing the adhesiveness of the bracket to the tooth.

FIGS. 3a and 3b show that quality of the bracket, namely the depth of the “throat” of the bracket which allows the jaws to be wired so as to achieve horizontal and vertical jaw mobility.

FIGS. 4a, 4b and 4c show the three basic orientations for placing the brackets: 4a. bracket straight up and down; 4b. top edge of the bracket angled toward front of mouth; 4c. top edge of the bracket angled toward back of mouth. The orientation with top edge of the bracket angled toward the back of the mouth (4c) is optimal for most bites.

FIGS. 5a and 5b show an alternative wiring pattern through the long axis of the bracket allowing jaws to be farther apart when needed for comfort. FIG. 5a shows a receding lower jaw (Class II bite). FIG. 5b shows a forward-jutting lower jaw (Class III bite).

FIGS. 6a and 6b show alternative types of attachments that can be used to wire the teeth apart: FIG. 6a shows the use of a “self-ligating” bracket 80 bonded to the top row of teeth as an alternative to the Begg bracket. FIG. 6b shows the use of eyelets 82 bonded to the bottom row of teeth. The eyelet 82 is the most elementary type of attachment that could enable the provider to wire the jaws apart.

FIG. 7 shows the typical wiring pattern using the alternative attachments shown in FIGS. 6a and 6b. The self-ligating brackets 80 on the upper teeth are shown with the “window” open. When the window is closed the wire becomes secured in the bracket slot. The eyelet 82 attachments are shown on the lower teeth.

### DETAILED DESCRIPTION OF THE INVENTION

### A. Introduction

Unlike other dental applications which close the jaws completely or employ removable devices to limit, slow down or constrain the ingestion of solid foods, the current invention encourages and promotes a limited separation of the jaws, is kept on at all times and consequently mandates the patient be limited to a liquid diet.

Key features of the invention that distinguish it uniquely from the Prior Art purporting to control or treat overeating are as follows:
1. The device makes use of brackets and other kinds of attachments bonded to the teeth around or through which wires are used to limit the mouth opening to a measured amount.
2. The semi-closed position is consonant with the normal rest position of a patient's mouth.
3. No dental molds are required to fabricate the device at a laboratory, as the device is comprised of simple parts well known dentists, especially orthodontists, who work daily with them. Thus, the device is affixed in one patient visit, in a way that mimics how an orthodontist places braces on a patient's teeth.
4. The device cannot be removed from the patient's mouth without the aid of a tool to cut the wires, and is therefore acting 24 hours a day enhancing its effectiveness in limiting ingestion of solid foods.
5. The method for using the invention takes cognizance of the need for the jaw joint to be exercised every five weeks to prevent stiffening.
6. The device has been used in practice by the Inventor for the past five years and has been shown to be safe and effective in controlling overeating.

OJW is typically initiated by the patient reading a document that describes OJW including the scope and limitations of the device and method for treating and controlling obesity. The patient then completes an information set including their medical and dental history, which the provider then reviews in the context of pre-defined suitability criteria to determine if the patient is a suitable candidate for OJW.

Patients deemed to be suitable based on the information set are then physically examined with special attention to the health and firmness of the gums, teeth and jaw joint. X-rays of the teeth and jaw are taken to rule out dental and jaw pathology.

If the candidate is acceptable for OJW based on the physical examination, the OJW device is attached to the teeth, and the jaws wired apart, as described above and as shown in the drawings.

The provider monitors the health and functioning of the patient's teeth, gum and jaw joints every five weeks—a period of time consonant with the frequency an orthodontist schedules regular office visits for patients.

### B. Preferred Embodiments

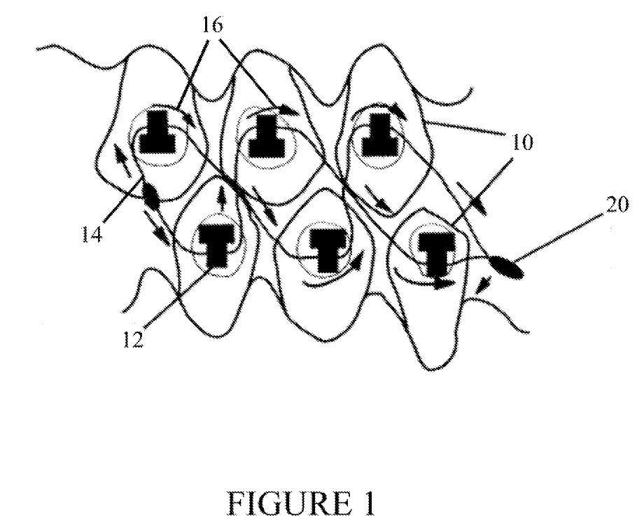

FIG. 1 is a schematic of the right side of the mouth depicting the most frequent pattern and method of jaw wiring. FIG. 1 also shows the teeth that are meant to bear the attachments. Right side canine teeth 10 are shown. Shown are attachments 12 bonded to teeth and dead soft wire 14 in the range of 0.012-0.018 inch. FIG. 1 shows the “FIG. 8” wiring configuration 16 used in the majority of cases, direction of wire weaving is shown by the arrows. Ends of wire 14 are twisted together 20. The teeth do not touch and the lower jaw is suspended 2.0-4.0 mm.

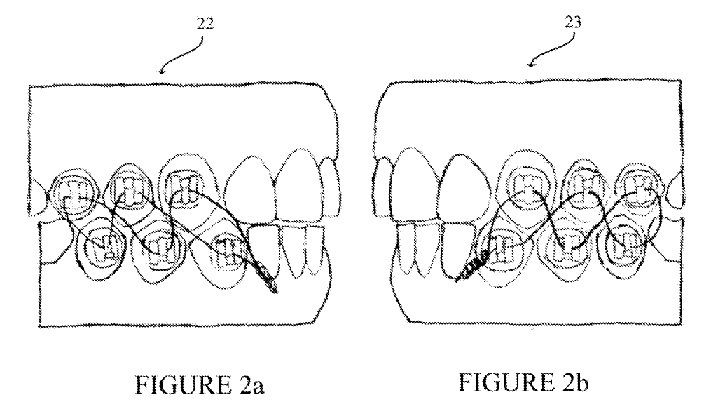

FIGS. 2a and 2b are side views indicating that right 22 and left 24 sides of the mouth are wired identically to achieve equal sided symmetry and balance.

A provider of jaw wiring could also choose 1. teeth immediately adjacent to the teeth shown, 2. a variety of attachments to bond the teeth, 3. a variety of materials to ligate the teeth together other than wire, 4. a variety of wiring patterns different than the one shown.

The device is assembled by the dentist/provider by bonding brackets to the upper and lower, right and left, first and second premolars and canines, i.e., teeth: #4, 5, 6, 29, 28, 27, 11, 12, 13, 22, 21 and 20, (according to the Universal Numbering System), with a self-curing adhesive or a light-curing bonding technique.

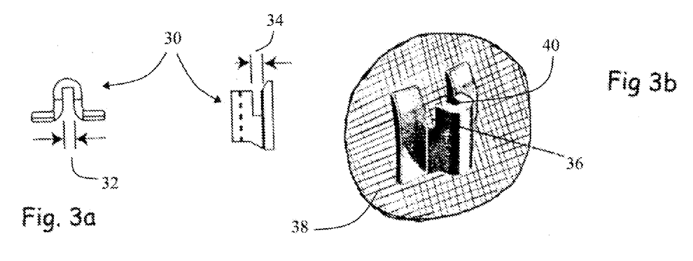

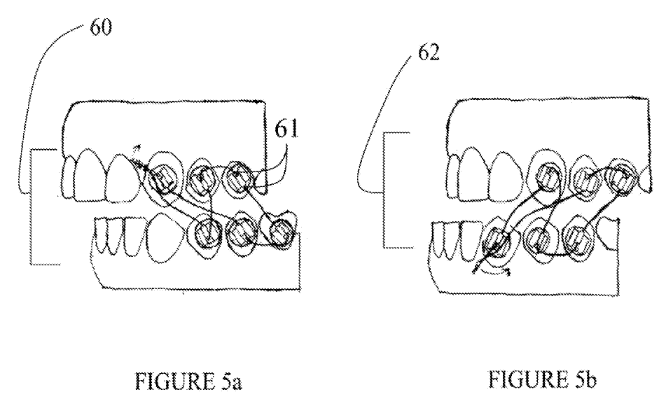

FIGS. 3a and 3b show the quality of the bracket 30, namely the depth of the “throat” 36 of the bracket 30 which allows the jaws to be wired so as to achieve horizontal and vertical jaw mobility. FIG. 3a shows a top view and side view of bracket 30, with a first dimension 32 and a second dimension 34 which may both be 0.51 mm or 0.20 inch. In one embodiment, a “Begg”-type bracket as shown in FIG. 3b is welded to a circular mesh pad 38. The “throat” 36 of the bracket is deep (1.14 mm), and the bracket has a hollow center passage 40 allowing a 0.014″-0.016″ diameter wire to pass through it see also FIG. 5a and 5b.

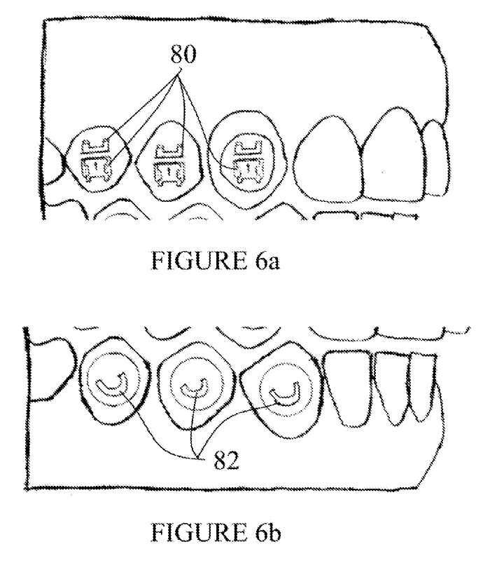

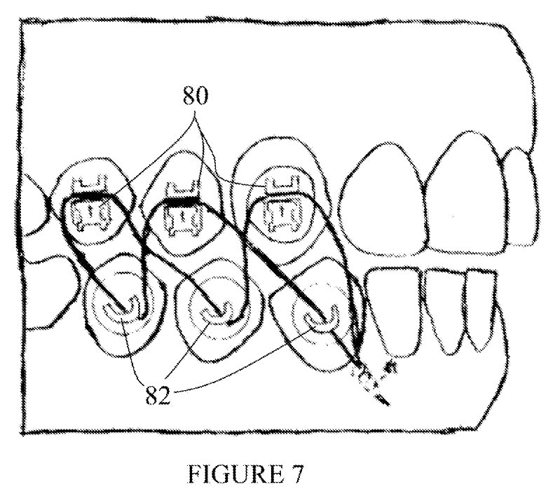

In another embodiment, a “self-ligating” bracket (FIG. 6a ) is used to attach the wire to the teeth.

In another embodiment, an “eyelet” (FIG. 6b) serves as an alternative to the “Begg”-type bracket.

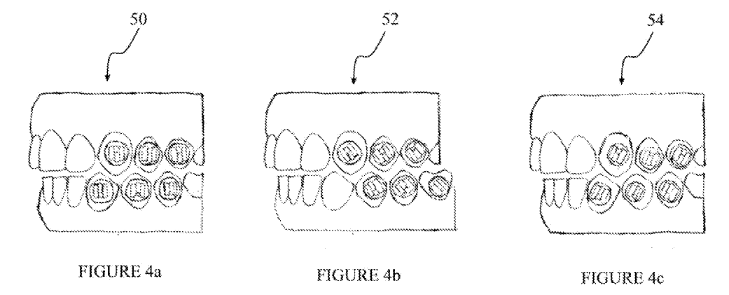

The brackets are bonded to the teeth in one of three unique orthodontic orientations (“angulations”) corresponding to how the patient bites bracket vertical edges straight up and down 50, Fig 4a, bracket top edge angled toward front of mouth 52 in FIG. 4b, bracket top edge angled toward back of mouth 54 in FIG. 4c, the orientation with bracket top edge angled toward the back of the mouth 54, is optimal for most bites.

The orientations with (a) bracket top edge angled toward the back of the mouth and (b) bracket vertical edges angled straight up and down, FIG. 4a, are suitable for most Class I bites (“normal” bites in which the lower jaw neither grossly recedes nor grossly juts forward). The orientation with bracket top edge angled toward the front of the mouth, FIG. 5a is optimal for gross Class II bites in which the lower jaw is severely receding while FIG. 5b shows the top edge back angulation is most suitable to patients who present with a grossly protruding lower jaw.

Bonding the brackets using the self-curing adhesive method takes 30-45 minutes and using the “light cure” adhesive method about 25-35 minutes for a practitioner who is skilled is the art.

After the brackets are bonded the provider instructs the patient to move the upper and lower teeth as lightly together as possible and begins wrapping “dead soft” wire, starting at the most posterior tooth bearing a bracket, around the brackets in a “figure 8” configuration (FIG. 1) similar to tying one's shoe laces—a maneuver well-known to orthodontists who apply it mostly to the anterior teeth. The wire diameter in the preferred embodiment is 0.014″, however, a range of wire diameter between 0.012″ and 0.018″ might also be suitable depending on the provider/patient'unique requirements.

The provider typically completes the “figure 8” sequence by bringing both ends of the wire together in front of the lower canine. Using a needle holder, such as a “Mathieu” wire holding instrument, the provider seizes the ends of the wires ½″ from the tooth and twists multiple times—typically 6-9—to adjust the tension of the wire wrapped around the teeth while simultaneously harmonizing the twisting with what he observes in so far as the wires lying passively in the throat of all six brackets. When the proper wire tension is achieved, the ends of the wire are cut off leaving a ¼″ tail of twisted wire which is tucked in so as to not scratch or otherwise irritate the patient.

The wiring procedure is repeated on the other side of the mouth, with the tension adjusted so as to create a bilaterally symmetrical and equal tension on both right and left sides of the patient's teeth (FIGS. 2a and 2b).

When right side and left side are wired the patient's lower jaw is effectively suspended by the wires approximately 2.0 mm from the upper jaw and is liberated to move the same amount to the right and left. In other embodiments, as in FIGS. 5a and 5b, up to a 4.0 mm opening between the upper and lower teeth is permitted by wiring through the vertical axis of a Begg-type bracket. This increased opening may be desirable for added patient comfort. In FIG. 5a as in one embodiment shown is a wiring pattern through the long axis 61 of the bracket allowing jaws to be farther apart when needed for comfort may be for a class II bite 60 as shown here. In FIG. 5b as in one embodiment the same wiring pattern as in FIG. 5a but used on a class III bite 62.When right side and left side are wired the patient's lower jaw is effectively suspended by the wires approximately 2.0 mm from the upper jaw and is liberated to move the same amount to the right and left. In other embodiments, as in FIGS. 5a and 5b, up to a 4.0 mm opening between the upper and lower teeth is permitted by wiring through the vertical axis of a Begg-type bracket. This increased opening may be desirable for added patient comfort. In FIG. 5a as in one embodiment shown is a wiring pattern through the long axis 61 of the bracket allowing jaws to be farther apart when needed for comfort may be for a class II bite 60 as shown here. In FIG. 5b as in one embodiment the same wiring pattern as in FIG. 5a but used on a class III bite 62.

Properly wiring both right and left sides should take between 5-10 minutes at most for a provider skilled in the art.

Dentists will note that the “interocclusal” space (the distance the teeth are apart) is the position (but somewhat smaller) that is commonly known as the patient's position of “physiologic rest.” One can demonstrate this position intentionally by having the patient say “mama” and bringing their lips to touch in an unstrained manner.

When wired at the proper tension, the lower jaw will be suspended restfully in a teeth-apart position. In the context of OJW, this position shall be known as “Rothstein's OJW position of rest”.

The patient is shown how to place the wires on their teeth using a model of teeth wired with the device. They are also shown multiple ways to remove the wiring, and instructed to carry wire cutters with them at all times.

The patient is then provided a set of basic instructions and precautions to help them achieve their weight loss goals and protect them from harm, for example, to cut the wires in case of nausea, and at five week intervals to remove the wiring and exercise the jaw joints for several days—typically 4-6.

Accuracy and rapidity of wiring the patient with the device does not follow a steep learning curve. It is intuitive for anyone skilled in the art of orthodontia, and is readily learned by dental practitioners. Most patients find it surprisingly easy to accomplish themselves.

OJW allows the provider to create an individual, unique variable semi-open position of the jaws—typically 2.0-4.0 mm apart—which prevents the patient from eating solid foods.

The patient typically removes the device for 4-6 days every 5 weeks to allow the jaw joint to be exercised, and returns to the provider to be examined and rewired.

In essence, in OJW the lower jaw is suspended from the upper jaw in an unstrained rest position which permits the jaw a range of mobility that minimizes jaw joint stiffening over time and minimally impairs speech.

What is claimed as being new and desired to be protected by a patent of the U.S. is as follows:

1. A device for suspending the lower jaw from the upper jaw in a partially opened, semi-mobile rest position consisting of bondable orthodontic attachments such as brackets (self-ligating, metallic, crystalline, plastic or combinations of all) or eyelets bonded to the canines and premolars of the upper and lower jaws around and/or through which are laced “dead-soft” wire to effectuate a measured degree of jaw separation sufficiently constraining to prevent the ingestion of solid food, yet sufficiently permissive to allow jaw exercise and speech clarity.

2. A device for suspending the lower jaw from the upper jaw as described in claim 1, using a bondable orthodontic bracket with a grooved throat or channel through which the wire passes and rests passively.

3. A device for suspending the lower jaw from the upper jaw as described in claim 2 using a particular bondable orthodontic bracket known as the “Begg” bracket.

4. A device for suspending the lower jaw from the upper jaw as described in claim 1, using bondable orthodontic brackets classified as “self-ligating”.

5. A device for suspending the lower jaw from the upper jaw as described in claim 1, using bondable orthodontic attachments classified as “eyelets”.

6. A device for suspending the lower jaw from the upper jaw as described in claim 1, using bondable orthodontic attachments made of metal, crystalline, plastic or combinations of these materials.

7. A device for suspending the lower jaw from the upper jaw as described in claim 1, where the material used to suspend the lower jaw from the upper jaw is dead-soft stainless steel wire with diameter ranging from 0.012″ to 0.018″.

8. A device for suspending the lower jaw from the upper jaw as described in claim 1, where the material used to suspend the lower jaw from the upper jaw is a non-metallic substance such as a synthetic polyester or plastic.

9. A method for suspending the lower jaw from the upper jaw in a partially opened, semi-mobile rest position consisting of bondable orthodontic attachments such as brackets (self-ligating, metallic, crystalline, plastic or combinations of all) or eyelets bonded to the canines and premolars of the upper and lower jaws around and/or through which are laced “dead-soft” wire to effectuate a measured degree of jaw separation sufficiently constraining to prevent the ingestion of solid food, yet sufficiently permissive to allow jaw exercise and speech clarity.

10. A method of suspending the lower jaw from the upper jaw as described in claim 9, where the attachments bonded to the teeth are oriented in a straight up and down position with respect to the vertical axis of the teeth.

11. A method of suspending the lower jaw from the upper jaw as described in claim 9, where the attachments bonded to the teeth are oriented with top edge of the attachments oriented toward the front of the mouth.

12. A method of suspending the lower jaw from the upper jaw as described in claim 9, where the attachments bonded to the teeth are oriented with top edge of the attachments oriented toward the back of the mouth.

13. A method for suspending the lower jaw from the upper jaw as described in claim 9, where the wire is laced around or threaded through the long axis of the Begg brackets so as to effectuate a separation of the teeth of 2.0 mm-4.0 mm.

14. A method of suspending the lower jaw from the upper jaw as described in claim 13 where the lower jaw is suspended from the upper jaw by threading the wires around the brackets specifically in a “figure eight” configuration such that the lower teeth are suspended from the upper teeth by a separation between the teeth of 2.0 mm.

15. A method of suspending the lower jaw from the upper jaw as described in claim 13 using a wiring configuration such that the wire passes through the long axis of the Begg brackets bonded to the teeth effectuating a 2.0 mm-4.0 mm. space between the upper and lower teeth.
